(19) United States
(12) Patent Application Publication
(10) Pub. No.: US 2002/0065757 A1
(43) Pub. Date: May 30, 2002

(54) Computer auction processing system and methods of managing such system

(76) Inventor: Amy Lam, Toronto (CA)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(21) Appl. No.: 09/536,531

(22) Filed: Mar. 28, 2000

(51) Int. Cl. G06G 1/12

(52) U.S. Cl. 705/37; 705/26

(57) ABSTRACT

The present invention is directed to an auction processing system, wherein one or more persons may participate in an auction provided by such system using a networked remote computer. The auction processing system comprises:

(a) a host computer which is capable of communication with at least one remote computer;

(b) means for generating currency, wherein the currency is generated by interaction with the host computer by a user of the remote computer; and

(c) means for enabling acquisition of one or more lots of merchandise through an auction format whereby such acquisition is through use of the generated currency.

Thus, importantly, the currency utilized in the auction is generated by interaction with the host computer (e.g., responding to games, polls, and surveys). The currency generated through such interaction may be monetary or otherwise, preferably otherwise. Thus, the currency generated may be, e.g., point valuations, whereby the auctioned good or service is obtained in exchange for generated point valuations.

Thus, the present invention is further directed to methods of managing an auction comprising:

(a) providing a host computer which is capable of communication with at least one remote computer;

(b) enabling the generation of currency comprising providing means for interacting with the host computer by a user of the remote computer; and

(c) enabling acquisition of one or more lots of merchandise through an auction format whereby such acquisition is through use of the generated currency.

### FIELD OF THE INVENTION

The present invention relates to the field of computer-based auction processing systems and methods of managing such systems. Thus, the present invention is directed to interactive auctions managed through an electronic network.

### BACKGROUND OF THE INVENTION

Auctions have been traditionally conducted in the physical presence of a number of persons interested in obtaining certain goods or services. Auctions are typically preceded by an offering, for example, through distribution of a catalog, such that the interested persons can pre-determine which goods or services appear interesting and the purchase price such person is willing to offer. Such auctions have the disadvantage of being slow and tedious, and not consistently directed to a good or service of interest. Additionally, many persons are often precluded from participating in traditional auctions because physical presence is often advantageous or required.

Most recently, the advent of computer-based auctions has improved the traditional auction format by accelerating the process, allowing persons to focus only on goods or services of interest, and allowing persons to participate in auctions from any location having a networked computer. For example, computer-based auctions will utilize the Internet's World Wide Web (“www”) to describe available goods or services and communicate various bids for such goods or services. See e.g., Fisher et al., U.S. Pat. No. 5,835,896, assigned to Onsale, Inc., issued Nov. 10, 1998 and Godin et al., U.S. Pat. No. 5,890,138, assigned to Bid.com International Inc., issued Mar. 30, 1999. Accordingly, persons are now able to compete for goods and services of interest from a convenient location during any convenient time of day. Thus, auctions are now increasingly available to a wide, diverse population.

Unfortunately, however, the currently available auction formats, and those described in the patent literature, require an expenditure of monetary currency in order to successfully compete for a particular good or service. Additionally, goods or services which are auctioned via computer typically command high monetary currency values. Thus, these auctions are exclusive of those persons having a lack of, or limited amount of, monetary currency.

The present inventors have designed an exciting auction processing system which alleviates the foregoing problems. The system described herein is inclusory of a variety of persons, having different ages and financial situations. In accordance with this system, possession of monetary currency, prior to participating in the auction, is not a requirement for participation. Rather, the present inventors have excitingly designed an auction processing system whereby “currency” (i.e., monetary or otherwise, preferably otherwise) is generated in part or in whole through interaction with the managing system of the auction (i.e., host computer). Accordingly, any person, regardless of their financial situation, can generate the currency needed to successfully participate in such auction. Additionally, managers of the auction can receive valuable information, rather than monetary currency, in exchange for the auctioned goods or services.

Accordingly, as described herein, the present invention is directed to an auction processing system in which the currency required for participation is generated, in part or in whole, through interaction with the managing system of the auction. As will be discussed, this system is particularly advantageous for inclusion of children or other persons having little or no access to monetary currency. This system is further particularly advantageous for managers of the auction, which can retrieve valuable information, e.g., consumer information, polling information, and survey information, in exchange for the auctioned goods or services.

### SUMMARY OF THE INVENTION

The present invention is directed to an auction processing system comprising:

(a) a host computer which is capable of communication with at least one remote computer;

(b) means for generating currency, wherein the currency is generated by interaction with the host computer by a user of the remote computer; and

(c) means for enabling acquisition of one or more lots of merchandise through an auction format whereby such acquisition is through use of the generated currency.

The currency generated through such interaction may be monetary or otherwise, preferably otherwise. Thus, the currency generated may be, e.g., point valuations, whereby the auctioned good or service is obtained in exchange for such generated valuations. The currency is generated, in whole or in part, through interaction with the host computer.

The present invention is further directed to methods of managing an auction comprising:

(a) providing a host computer which is capable of communication with at least one remote computer;

(b) enabling generation of currency comprising providing means for interacting with the host computer by a user of the remote computer; and

(c) enabling acquisition of one or more lots of merchandise through an auction format whereby such acquisition is through use of the generated currency.

### DETAILED DESCRIPTION OF THE INVENTION

The present invention relates to the field of computer-based auction processing systems and methods of managing such systems. Thus, the present invention is directed to interactive auctions managed through an electronic network.

Publications and patents are referred to throughout this disclosure. All references cited herein are hereby incorporated by reference.

In the description of the invention various embodiments and/or individual elements are disclosed. As will be apparent to the ordinarily skilled practitioner, all combinations of such embodiments and elements are possible and can result in preferred executions of the present invention.

The compositions, methods, and kits herein may comprise, consist essentially of, or consist of any of the elements as described herein.

### The Auction Processing System and Methods for Managing Auction

The present auction processing system provides a means for persons, of any age or financial situation, to obtain goods or services (collectively referred to herein as “merchandise” for simplicity) using a computer network. As will be described, the currency utilized to obtain such merchandise is generated, in whole or in part, by interaction with the host computer managing the auction. Thus, persons utilizing the present system have the capability to obtain merchandise without the need for independently generated currency, monetary or otherwise.

Accordingly, persons utilizing the present systems are often those having limited or no access to monetary currency. It is therefore a preferred embodiment herein for children to utilize the present systems, for example, those between the ages of about five to about eighteen years of age, more preferably from about five to about fourteen years of age, and most preferably from about six to about fourteen years of age. Additionally, the present systems are particularly directed to persons who do not wish to obtain merchandise by using independently accumulated monetary currency, but rather wish to interactively provide or receive information in exchange for the ability to compete for merchandise through the presently described bidding process.

The present invention is directed to an auction processing system comprising:

(a) a host computer which is capable of communication with at least one remote computer;

(b) means for generating currency, wherein the currency is generated by interaction with the host computer by a user of the remote computer; and

(c) means for enabling acquisition of one or more lots of merchandise through an auction format whereby such acquisition is through use of the generated currency.

The auction processing system is preferably implemented in software and allows one or a plurality (preferably, a plurality) of bidders to interactively generate currency for use in such auction processing system, and thus use such generated currency to compete for merchandise through a bidding process.

Methods of managing an auction processing system are also contemplated herein. The method comprises:

(a) providing a host computer which is capable of communication with at least one remote computer;

(b) enabling generation of currency comprising providing means for interacting with the host computer by a user of the remote computer; and

(c) enabling acquisition of one or more lots of merchandise through an auction format whereby such acquisition is through use of the generated currency.

Each of these components is more particularly described herein below. Additionally, Fisher et al., U.S. Pat. No. 5,835,896, assigned to Onsale, Inc., issued Nov. 10, 1998, may be consulted as a reference. However, as will become apparent, the present invention differs from the system described therein in several important respects.

### The Host Computer

As described herein, the host computer is an integral component of the present invention. The host computer may be any object which acts as a source of information or signals. The term “host computer” can refer to any type of computer, for example, a centralized mainframe which is a host to its terminals, a server which is host to its users, or a desktop personal computer which is host to its peripherals. In network architectures, a client station (user's machine) is also considered a host, because it is a source of information to the network, in contrast to a device such as a router or switch which directs traffic. Preferably, the host computer is one or more centralized computers which enable the conduction of a networked computer auction. The auction preferably operates through software running on the host computer. Thus, the host computer may take a variety of forms, wherein the form is not critical to the operation of the present invention. Additionally, the host computer may be, but need not be, a plurality of computers (including any objects capable of implementing software of performing commands), which are networked together to form a communication link.

The host computer is capable of communication with at least one remote computer. As used herein, “capable of communication” means that the host computer and remote computer(s) exchange information through any of a variety of network links, including telephone lines, cable, fiber optic transmission, satellite, and/or any of a variety of other communication links.

Thus, the host computer will be attached or otherwise linked to a network which is accessible to one or a plurality (preferably, a plurality) of persons through at least one, but preferably a plurality of, remote computers. A particularly preferred network for implementing the present invention is the Internet (www), however, the network may also preferably be “intranets” or partially closed networks.

The host computer will include software, a database, or otherwise beneficial function for maintaining and communicating (to the remote computers), e.g., the host computer may store information such as descriptions of merchandise lots for auction, bid information, bid increments, successful bidder information, and auction outcome.

### The Remote Computers

The host computer herein is capable of communication with at least one remote computer. Most preferably, the host computer is capable of communication with a plurality of remote computers. Such plurality may be high. For example, the number of users, and thus remote computers, herein is only limited by the number of remote computers globally available (thus, essentially, not limited).

As with the host computer, the remote computers may take a variety of forms, wherein the form is not critical to the operation of the present invention. The remote computer must be capable of communication with the host computer.

### Means for Generating Currency

A critical element of the present invention is a means for generating currency, such that any user may participate in the auction processing system. The currency utilized to obtain the merchandise available from the auction is generated, in whole or in part, by interaction with the host computer managing the auction. Thus, persons utilizing the present system have the capability to obtain merchandise without the need for independently generated currency, monetary or otherwise.

The currency is therefore generated by interaction with the host computer by a user of the remote computer. The system may be constructed in such a way that any, or certain, interaction with the host computer generates currency. The currency may be provided in physical form to the user (e.g., using standard mail delivery systems) or may be stored in a database of the host computer. Preferably, the currency is stored in a database of the host computer. A portion or all of such currency may then be utilized for bidding on and/or obtaining one or more lots of merchandise through the presently described auction format.

As used herein, the term “interaction” means that the user of the remote computer communicates information to the host computer or receives information from the host computer, preferably at the request or prompt of the host computer. Such information may be useful or non-useful information for the manager of the host computer. Non-limiting examples of useful information include responses to inquiries, surveys, polls, and tests, and provision of consumer information (including consumer preferences or identification of other persons who may have interest in the auction processing system, or merchandise obtainable from such system).

To illustrate, for example, the information communicated may be a response to a consumer product concept survey (such concept being provided by the host computer) or one or more questions directed to consumer preferences of the user. Surveys may be updated, e.g., weekly, by the host computer and, using password or other validation systems, the host computer may optionally allow only one completion of any given survey by any given user. Additionally, the information may be a communication (electronic or otherwise) by a user of the remote computer to a third party having interest in the auction processing system, or merchandise obtainable from such system. Non-limiting examples of non-useful information includes responding to games posted by the host computer (i.e., “playing” games through use of the remote computer), or suggesting game formats to the host computer (e.g., creating a game for use by the host computer). Preferably, at least one interaction is selected from responding to games, receiving information, and responding to surveys.

As stated, the term “interaction” may also mean that the user of the remote computer receives information from the host computer, preferably at the request or prompt of the host computer. Thus, the host computer may offer, for example, informational content about a particular product or educational information. The user of the remote computer may optionally confirm understanding of such information by electronic means through, for example, an electronic mail message or through a response to questions directed to such information. The host computer may then assign currency values to the user, preferably as stored in a point valuation account, which may be utilized by the user to compete for merchandise in the auction format.

In a preferred but optional embodiment of the present invention, the currency may be additionally generated through obtaining a commercially available product. For example, the owner or contractor of the host computer may make available, through purchase or otherwise, a product bearing a valuation of currency for use in the present invention. Thus, for example, the product may convey a particular point valuation for use in the auction processing system, in addition to currency generated through interaction with the host computer. Point valuations may be confirmed by the host computer through, for example, communicating alpha or numeric codes or by transmitting a photo, copy, or original portion of the product through the mail or via electronic transmission.

The manager of the auction processing system (i.e., through the host computer) may assign currency quantity according to which interaction is utilized through the remote computers. Thus, for example, responding to a certain game may generate a certain amount of currency, while responding to a survey may generate yet a different amount of currency, and further obtaining a commercially available product may generate yet a different amount of currency. The assigned currency values generated herein are not critical to this invention.

The currency generated herein may be monetary or otherwise, preferably otherwise. Thus, the currency generated may be, e.g., point valuations, whereby the auctioned good or service is obtained in exchange for generated point valuations. Preferably, the currency is point valuations, wherein as described above, such point valuations are assigned by the manager of the auction (and thus communicated by the host computer). The currency may also be monetary currency, wherein such monetary currency is utilized in the auction processing system.

### Means for Enabling Acquisition of One or More Lots of Merchandise

The auction processing system further comprises a means for enabling acquisition of one or more lots of merchandise through an auction format whereby such acquisition is through use of the generated currency.

As used herein, the term “auction format” will be readily discernible to one of ordinary skill in the art. Various auction formats may be utilized, for example, standard auctions, “Dutch” auctions, progressive auctions, and decreasing price/time auctions. See e.g., Fisher et al., U.S. Pat. No. 5,835,896, assigned to Onsale, Inc., issued Nov. 10, 1998 and Godin et al., U.S. Pat. No. 5,890,138, assigned to Bid.com International Inc., issued Mar. 30, 1999. The chosen auction format is not critical to this invention, however, standard auctions are preferred. The host computer will preferably be programmed to utilize a defined auction format for any given lot of available merchandise.

To enable acquisition of one or more lots of merchandise, any of a variety of means may be utilized. See e.g., Fisher et al., U.S. Pat. No. 5,835,896, assigned to Onsale, Inc., issued Nov. 10, 1998; Godin et al., U.S. Pat. No. 5,890,138, assigned to Bid.com International Inc., issued Mar. 30, 1999; and Ausubel, U.S. Pat. No. 5,905,975, issued May 18, 1999. A particularly preferred means herein is described in Fisher et al., U.S. Pat. No. 5,835,896, assigned to Onsale, Inc., issued Nov. 10, 1998, with the important modification that at least some of the currency is generated through interaction with the host computer (rather than being independently obtained monetary currency), as has been described herein.

Thus, as a non-limiting example, a “merchandise database” which is descriptive of at least one merchandise lot available in exchange for the currency may be utilized. As used herein, the term “database” may include one discrete set of information or a plurality of discrete sets of information. The database is typically a collection of tables, i.e., the host computer may comprise one or more databases, containing one or more tables. Descriptions in the merchandise database may (but need not) specifically include, for example, physical descriptions, minimum bid requirements, bid history, current bid, quantity of lots available, amount of time remaining for bidding, and the like. The system may manipulate such database in order to create human-readable “catalog pages” for viewing at the remote computer location. Thus, output from the merchandise database is communicated to one or more of the remote computers, such that users may know what lots of merchandise are available for acquisition.

As a further non-limiting example, the auction processing system may comprise an “account database” wherein a user's registration information (e.g., name, electronic mail address, shipping address) and/or currency valuations are stored. For example, wherein currency is generated through the interaction described herein, sum totals of such currency may be stored by the host computer. Such sum totals are preferably accessible by the user of the remote computer through utilization of a password or some other form of identification. Additionally, wherein products bearing a valuation of currency are acquired, such valuations are optionally entered to a given user account by such user (alternatively, a user may keep a separate log of valuations not entered into the user account). Accordingly, using the account database, the user and the host computer have record of currency generated for use in the auction format.

As a further non-limiting example, the auction processing system may also comprise a bid database for storing and transmitting bid information, wherein the bid information is descriptive of a bid received from a user of a remote computer. Again, as used herein, the term “database” may include one discrete set of information or a plurality of discrete sets of information. Thus, the bid database may actually be a plurality of bid databases, for example, any of a number of databases for certain users of the remote computer or any of a number of databases for various merchandise lots.

Information for inclusion in the bid database may be communicated by a user of the remote computer. Thus, a user will typically submit bid information (e.g., name, password, electronic mail address, shipping address, age, bid identity (e.g., including an account number for stored currency), and the like) and/or a particular bid for a given lot of merchandise. Again, as is understood herein, the bid is enabled through currency generated, at least in part, through interaction with the host computer. Upon accessing the network and viewing the bid description for the lot of merchandise, the bidder may take an action which causes a bid form to be displayed on the screen of the remote computer. The bidder then enters the information necessary to place a bid (i.e., the bid information). The information is then electronically transmitted to the host computer.

The auction processing system receives the bid information and stores the information in a bid database. Because this new bid will typically be a bid for a higher valuation relative the previous bid for such lot of merchandise, the host computer will typically electronically update the lot's catalog page. The updated catalog page will display the “new” high bid to any users of the remote computer (i.e., prospective bidders) who later access that page.

The bid database of the host computer will also store the bid information and/or a particular bid. The bid database may accomplish this by extracting the relevant bid information from the bid and/or information submitted by a user of the remote computer. The bid information will be stored in the bid database and the bid database will update the merchandise catalog page. This process will typically be repeated, typically wherein the bidder increases a bid or wherein new users will bid on the particular lot of merchandise. This process will typically continue until the host computer detects that the lot of merchandise is scheduled to be closed for further bidding or another predetermined closing trigger is detected. Thus, at a predetermined time period, the bid database will then determine whether the user is successful or unsuccessful in bidding for the lot of merchandise requested. Typically, the successful bidder will have bid the highest currency value (e.g., highest point valuation). Optionally, such determinations are communicated to the user of the remote computer. Preferably, the determination is communicated to the successful bidder, and optionally the unsuccessful bidders, for any given lot of merchandise. Such communication to the user may be via a variety of forms, e.g., standard mail delivery or electronic mail delivery, preferably electronic mail delivery.

Methods for implementing the auction processing system described herein will be well-known to one of ordinary skill in the art. Fisher et al., U.S. Pat. No. 5,835,896, assigned to Onsale, Inc., issued Nov. 10, 1998 may also be consulted for reference.

The following sets forth non-limiting examples of the present invention, including implementation thereof. A variety of other embodiments will be well-known to one of ordinary skill having the benefit of this disclosure, and such other embodiments are included within the present invention.

### EXAMPLE 1

A company marketing a beverage product preferred by children desires to provide an auction processing system for children. Thus, the company, via a host computer, provides a “web site” (i.e., through the world wide web) which children may access via a remote computer. The web site communicates rules for the auction, a questionnaire for registration with the host computer, and interaction means to generate currency for use in the auction. The interaction means are responding to games (i.e., playing games). For example, the child responds to the game and earns point valuations for use in the auction, wherein such valuations are assigned by the host computer and recorded in the child's valuation account. Increased point valuations are provided wherein the child “wins” the game (e.g., achieves a certain score). Internet privacy policies, e.g., Children's Online Privacy Protection Act (COPPA) are followed in all respects. Additional point valuations are earned by purchasing or otherwise obtaining the marketed beverage product, wherein the marketed product communicates an assigned point valuation. The children may input point valuations earned through obtaining the marketed beverage product into his/her point valuation account. All point valuations are stored in a database by the host computer and individual point valuation accounts are accessible to any given child using a password. Using his/her earned point valuations, a child may bid on a lot of merchandise (e.g., toys, computers, music, or other tangible items or services) during a period of time prescribed by the host computer. The host computer posts available lots and minimum bid amounts on the web site. The host computer determines the highest bidder, and notifies such bidder of his/her successful bid (e.g., through electronic mail to the remote computer). The appropriate point valuation is then deducted from the successful bidder's account, as stored and electronically communicated by the host computer. The successful bidder confirms point valuations earned by obtaining marketed beverage products by sending a defined portion of the beverage product to the company (e.g., a label or bottle cap), or by communicating to the host computer a code set forth on the beverage product. The company, in return, ships the lot of merchandise to the successful bidder.

### EXAMPLE 2

A company interested in marketing beauty care products to women implements an auction processing system of the present invention. Thus, the company, via a host computer, provides a “web site” (i.e., through the world wide web) which women may access via a remote computer. The web site communicates a rules for the auction, a questionnaire for registration with the host computer, and interaction means to generate currency for use in the auction. The interaction means are responding to surveys about beauty care products, e.g., product preferences and unmet needs. Completion of the survey will earn point valuations for use in the auction. All point valuations are stored in a database by the host computer and individual point valuation accounts are accessible to any given woman using a password. Using the earned point valuations, any given woman may bid on a lot of merchandise (e.g., beauty products, music, books, vacations, or other tangible items or services) during a period of time prescribed by the host computer. The host computer posts available lots and minimum bid amounts on the web site. The host computer determines the highest bidder, and notifies such bidder of her successful bid (e.g., through electronic mail to the remote computer). The appropriate point valuation is then deducted from the successful bidder's account, as stored and communication by the host computer. The company ships the lot of merchandise to the successful bidder. Unsuccessful bidders are contacted by electronic mail, and no point valuations are deducted from the unsuccessful bidder's account. Throughout the auction process, no monetary currency is exchanged between the woman and the company.

What is claimed is:

1. An auction processing system comprising:
(a) a host computer which is capable of communication with at least one remote computer;
(b) means for generating currency, wherein the currency is generated by interaction with the host computer by a user of the remote computer; and
(c) means for enabling acquisition of one or more lots of merchandise through an auction format whereby such acquisition is through use of the generated currency.

2. An auction processing system according to claim 1 wherein the host computer is capable of communication with a plurality of remote computers.

3. An auction processing system according to claim 2 wherein the currency is non-monetary currency.

4. An auction processing system according to claim 3 wherein at least one interaction is selected from the group consisting of responding to games, receiving information, and responding to surveys.

5. An auction processing system according to claim 4 wherein at least one interaction is responding to games.

6. An auction processing system according to claim 4 wherein at least one interaction is receiving information.

7. An auction processing system according to claim 4 wherein at least one interaction is responding to surveys.

8. An auction processing system according to claim 4 wherein the currency is additionally generated through obtaining a commercially available product.

9. An auction processing system according to claim 5 wherein the currency is additionally generated through obtaining a commercially available product.

10. An auction processing system according to claim 6 wherein the currency is additionally generated through obtaining a commercially available product.

11. An auction processing system according to claim 7 wherein the currency is additionally generated through obtaining a commercially available product.

12. A method of managing an auction comprising:
(a) providing a host computer which is capable of communication with at least one remote computer;
(b) enabling the generation of currency comprising providing means for interacting with the host computer by a user of the remote computer; and
(c) enabling acquisition of one or more lots of merchandise through an auction format whereby such acquisition is through use of the generated currency.

13. A method according to claim 12 wherein the host computer is capable of communication with a plurality of remote computers.

14. A method according to claim 13 wherein the currency is non-monetary currency.

15. A method according to claim 14 wherein at least one means for interacting is selected from the group consisting of responding to games, receiving information, and responding to surveys.

16. A method according to claim 15 wherein at least one means for interacting is responding to games.

17. A method according to claim 16 wherein at least one means for interacting is receiving information.

18. A method according to claim 17 wherein at least one means for interacting is responding to surveys.

19. A method according to claim 15 wherein enabling the generation of currency further comprises providing a commercially available product.

20. A method according to claim 16 wherein enabling the generation of currency further comprises providing a commercially available product.

21. A method according to claim 17 wherein enabling the generation of currency further comprises providing a commercially available product.

22. A method according to claim 18 wherein enabling the generation of currency further comprises providing a commercially available product.
